(19) United States
(12) Patent Application Publication
(10) Pub. No.: US 2014/0272010 A1
(43) Pub. Date: Sep. 18, 2014

(54) Edible Utensil and Method of Producing The Same

(71) Applicant: Laurie L. DeLaprym, Lakeville, CT (US)

(72) Inventor: Laurie L. DeLaprym, Lakeville, CT (US)

(21) Appl. No.: 13/797,792

(22) Filed: Mar. 12, 2013

(51) Int. Cl. A21D 13/00; A21D 8/02; A23G 9/50

(52) U.S. Cl. CPC A21D 13/009; A23G 9/506; A21D 8/02
USPC 426/95; 426/138; 426/504

(57) ABSTRACT

A composition and method for producing edible utensils is disclosed, more specifically to replace frozen dessert utensils currently used for confections.

### CROSS-REFERENCE TO RELATED APPLICATIONS

The present application claims priority back to Provisional Application Ser. No. 61/640,177 filed on Apr. 30, 2012.

### FIELD OF THE INVENTION

This invention relates to the field of edible utensils and edible supports for food products, such as frozen desserts and hot beverages.

### BACKGROUND

This disclosure relates to an edible support and/or edible utensil for use with food products, such as frozen desserts and hot beverages. Historically, frozen treat supports are non-edible and are typically made of wood (for example, popsicle sticks for ice cream). Typical hot beverage stirrers are made of either wood or plastic and are non-edible. Current edible utensils for frozen treats are made of pretzel-type materials which are water-permeable and brittle. Other edible supports are made from hard candy or gum.

### SUMMARY OF THE INVENTION

In one aspect, the invention relates to an Edible Utensil in which a cookie-based edible support is used to bear a frozen treat shaped portion. In another aspect, the Edible Utensil is used as a utensil to facilitate eating a frozen treat. The Edible Utensil is cookie-based, has a plurality of layers, and is substantially impermeable to liquid as well as being substantially durable after freezing and thawing, permitting it to serve as an edible-scaffold and/or edible-utensil for the consumption of a frozen dessert.

In another aspect, the invention relates to a method of producing a food product which serves as an Edible Utensil and/or Support where a powdered grain and a sweetener are combined to form a grain mixture, to which a fat is added, and the combined grain mixture is mixed to form a slurry. Optionally, flavoring may be added to the slurry. A dough base is formed by added milk to the slurry, followed by mixing the dough base from 2-10 minutes to form a wet dough which is kneaded until an elastic dough ball is obtained. The dough is rested, shaped and baked from 275° F. to 375° F. to form the edible food product which serves as an edible support and/or utensil. The above described and other features are exemplified by the following figures and detailed description.

Accordingly, it is an object of the present invention to provide an edible support for a food product wherein the support remains sufficiently rigid to support the food product during manufacture, transport, storage and ultimate consumption.

It is also an object of the present invention to provide an edible support for a frozen comestible such as ice cream, yogurt or the like.

It is yet another object of the present invention to provide an edible product which can be used as a utensil for eating another food item.

It is a further object of the present invention to provide an edible product which is easy and economical to manufacture.

It is also an object of the present invention to eliminate waste associated with disposable of non-edible supports for food products, and, in particular to lessen the need and use of wooden and plastic sticks.

It is a still further object of the present invention to provide supports for edible food products which are not candy and which thus can be made to be nutritious on their own.

It is also an object of the present invention to provide an edible support which is substantially impermeable to the food item which it is supporting, especially during storage and transport.

It is also an object of the present invention to provide a food product which can be readily colored.

Likewise, it is an object of the present invention to provide an edible utensil and/or food support which is readily capable of stamping, pressing and embossing operations so as to enable the display of words, art, designs. names, figures, logos, marks, etc.

Lastly, but not limited hereto, it is an object of the present invention to provide an edible support for holding a frozen dessert-like item during consumption, after which the support is also consumed.

The recitation herein of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE DRAWINGS

The subject matter which is regarded as the invention is particularly pointed out and distinctly claimed in the concluding portion of the specification. The invention, however, both as to organization and method of practice, together with the further objects and advantages thereof, may best be understood by reference to the following description taken in connection with the accompanying drawings in which:

FIG. 1 shows an embodiment of the Edible Utensil described herein as a pear-shaped disc;

FIG. 2 shows a translucent version of the pear-shaped disc, illustrating the portion inserted into the frozen dessert portion;

FIG. 3 shows an embodiment of the Edible Utensil described herein as a pear-shaped disc with a hole inserted into the grip portion;

FIG. 4 shows a translucent version of the pear-shaped disc with a hole inserted into the grip portion, illustrating more clearly the portion inserted into the frozen dessert portion;

FIG. 5 shows an embodiment of the Edible Utensil described herein as a stick;

FIG. 6 shows a translucent version of the stick shaped Edible Utensil, illustrating more clearly the portion inserted into the frozen dessert portion;

FIG. 7 shows an embodiment of the Edible Utensil which is shaped substantially like a spoon;

FIG. 8 shows an embodiment of the Edible Utensil which is shaped into a pear-shaped disc and which may be used as a utensil;

FIG. 9 shows an embodiment of the stick-shaped Edible Utensil;

FIG. 10 shows a cross-section of an embodiment of the stick-shaped Edible Utensil, with the plurality of layers;

FIG. 11 shows a side view and a cross-section of one embodiment of the stick-shaped Edible Utensil, with the plurality of layers; and

FIG. 12 shows a close-up of a cross-section of one embodiment of the stick-shaped Edible Utensil, with the plurality of layers.

### DETAILED DESCRIPTION

In one aspect, the invention relates to an Edible Utensil in which a cookie-based edible support is used to bear a frozen treat shaped portion. In another aspect, the Edible Utensil is used as a utensil to facilitate eating the frozen treat. The Edible Utensil is substantially a cookie and is substantially impermeable to liquid, which permits it to serve as a scaffold or utensil while the frozen treat is being consumed. The Edible Utensil is also durable after freezing-thawing which permits for a non-brittle utensil and/or support for frozen treat consumption. The Edible Utensil also possesses a plurality of layers.

In another aspect, the invention relates to a method of producing a food product which serves as an Edible Utensil and/or Support where a powdered grain and a sweetener are combined to form a grain mixture, to which a fat is added, and the combined grain mixture is mixed to form a slurry. Optionally, flavoring may be added to the slurry. A dough base is formed by added milk to the slurry, followed by mixing the dough base from 2-10 minutes to form a wet dough which is kneaded until an elastic dough ball is obtained. The dough is rested, shaped and baked from 275° F. to 375° F. to form the edible food product which serves as an edible support and/or utensil. The above described and other features are exemplified by the following figures and detailed description.

“Cookie” refers to any baked, small, flat or slightly raised cake. “Frozen treat” and “frozen dessert” refers to any sweet dessert which is consumed in a substantially frozen state (such as, but not limited to, ice cream, frozen yogurt, sherbet, pies, cakes, popsicle).

Some of the advantages include (but are not limited to) that the food product is completely edible. In addition, the ingredients may be customizable, with various flavoring combination that may be used. The food product also is suitable for mass production. It is cost effective, eco-friendly as it is biodegradable, and is complimentary to frozen confections, hot and cold beverages, and desserts. In one embodiment, the product may be made from all-natural and/or organic ingredients. Additionally, the food product may be customized to suit various dietary restrictions, such as vegan diets, low-sugar diets, and gluten-free diets. The product may also be produced in an unlimited variety of shapes, colors, and flavors.

### Composition and Method

Ratio of Ingredients:

In one embodiment (see Embodiment 1 below), the edible utensil contains from 6 parts powdered grain (±20%), 3 parts liquid (±20%), and 1 part fat (±20%). Sweeteners and/or flavorings are optional. The ratio of these ingredients depends on the type of grain, liquid, and fat being used. In Embodiment 1, additional flour can result in a dry and crumbly mixture, while less flour may result in a wet/sticky dough. In Embodiment 1, too much butter may disturb the oven temperature, bake time, and the finished product, while less butter may result in a product that absorbs liquid at a much faster rate, resulting in brittle sticks that lack proper water impermeability. In Embodiment 1, less milk may result in clumpy, difficult to smooth out dough, while more milk may make the dough sticky and lumpy.

Powdered Grain:

Traditional wheat flours (such as all purpose, whole wheat, bread flour, etc) may be used in selective embodiments. Non-traditional grains may also be used to vary consistency, taste, flavor and/or to meet and cater to persons with dietary restrictions (e.g., gluten free). Such exemplars include, but are not limited to, use of nut flours, rice flour, soy flour, maize flour, potato flour, etc. Any other commercially known powdered grain may also be substituted if suitable.

Butter:

Traditional fats (such as butter, margarine, vegetable shortening, oil, egg yolks) may be used in selective embodiments. Non-traditional fats may also be used to vary consistency, taste, flavor and/or to meet and cater to persons with dietary restrictions (e.g., vegan diets and/or lactose-intolerant individuals). Such exemplars include, but are not limited to, use of nut fats (e.g., almond butter), coconut butter, cocoa butter, etc. Any other commercially known fats may also be substituted if suitable.

Liquid:

Traditional liquid (such as whole milk, fat free milk, low fat milk)) may be used in selective embodiments. Non-traditional liquids may also be used to vary consistency, taste, flavor and/or to meet and cater to persons with dietary restrictions (e.g., vegan diets and/or lactose-intolerant individuals). Such exemplars include, but are not limited to, use of water (with or without powdered milk additive), buttermilk, soy milk, rice milk, almond milk, lactose-free milk. Any other commercially known fats may also be substituted if suitable. The use of room temperature liquid results in a superior process and product.

Flavorings:

Flavorings may optionally be added as desired. Vanilla extract is a potential flavoring embodiment which adds a light taste which complements the confections used in the experiments. The amounts of vanilla can be increased or decreased, depending on intensity of desired vanilla taste. Other flavorings may be used (including, but not limited to peppermint, almond, orange and lemon, etc). Flavor strength depends on how much is used and desired flavor in finished product. Since very little amounts of added concentrated flavors are required, the added liquid of said flavorings does not make a difference in finished product.

Sweetener:

The use of sweeteners is optional to the final composition of the product. Salt may be substituted or used in addition to a sweetener. The use of sweeteners may be varied to yield varying consistency, taste, flavor and/or to meet and cater to persons with dietary restrictions/needs. Examples of sweeteners include, but are not limited to: cane sugar, raw sugar, brown sugar, honey, molasses, artificial sweeteners, natural sweeteners, syrups (e.g., corn, brown rice), etc. Any other commercially known sweetener may also be substituted if suitable.

Oven Temperature:

Various oven temperature may be used for baking the final product, including, but not limited to anywhere from 275° F.-375° F. Oven temperature may need to be adjusted depending on the ingredients used. Raw dough shrinks slightly while baking.

Bake Time:

The baking time may be adjusted depending on the ingredients used and also the oven used. It has been found that oven models, age and elevation are a factor in the finished product.

Order of Ingredients:

A desirable element to this recipe is to have a finished product that offers an alternative to existing products currently on the market. A product void of chemicals and preservatives, cost effective and having the ability to withstand certain utility uses. Through the experimentation process, it has been discovered that the order of ingredients in the raw stage does influence the end result. Embodiment 1 describes an embodiment of the process for making the edible utensil.

Dough Preparation:

Preparing the dough has been found to be another desirable element for the overall strength of the finished product. If the raw dough has any air bubbles, wrinkles or creases, the finished product is weak and fractures easily occur at those points.

### Properties

Appearance:

The exterior surface of the Edible Utensil has a somewhat “glossy” skin. It is dry and smooth to the touch which protects the interior and structural integrity so as to not allow immediate penetration of liquid or substances which are in the process of becoming liquid. Doodles may be scored into the raw dough using a knife tip and razor blade prior to baking There is no change in any aspect of the Edible Utensil, therefore, stamping or embossing logos, letters, etc. will not hinder the use of the Edible Utensil. The color of the Edible Utensil prototype is a light, golden brown—similar to baked bread. Utilizing different colors is possible and may be desirable.

### Structural Properties

Water Impermeability:

Testing the structural integrity of the finished product is done by submerging half of the finished product in liquid for durations of up to 12 minutes. The sticks are analyzed and tested every 2 to 3 minutes throughout the process. The results are such that the finished product retained its texture, strength, taste and color with unremarkable penetration of the liquid. At 12 minutes, the exterior layer of the finished product begins to slough off in thin layers; however, the finished product retains its strength and crispness even at that point. The same tests are performed after the sticks are placed in liquid then put into a freezer for 6 days. Freezing the finished product makes no difference. Results are the same as above.

Freeze Durability:

All batches are tested for durability by using store purchased ice cream, letting the ice cream stand until soft enough to pack into new shapes, inserting an edible utensil and re-freezing. The new shapes are made by using store purchased plastic ice cream molds and different sizes of paper and plastic cups. Individual batches are placed in the back of a household freezer ranging from 3 hours to 6 days. It is likely that commercial flash freezing will offer the same or better results as a household freezer. Freezing the Edible Utensil offers great results as it maintains structural integrity, taste, color and texture; therefore, they offer an excellent substitute for the current frozen confection stick currently on the market.

Edibility at Varying Temperatures:

The structure of the edible utensil is such that it is soft enough such that it may be eaten (i.e., chewed comfortably by the human jaw) either at room temperature or when fully frozen, while still retaining a commercially desirable edible texture that is crunchy/crispy.

Applicants are not required to provide a description of the theory of operation of the invention and the appended claims should not be limited by the applicants statements regarding such theory, but it is thought that one or more of the following desirable properties of the Edible Utensil/Support—namely freeze-thaw durability, water-impermeability, edibility at varying temperatures—are related to the structure of a plurality of aerated cookie-based layers. The methodology of kneading and folding the dough in raw stage is used to form the layers in finished product. Layers within the structure of the finished product are believed to be highly desirable for overall crispness (flaky texture) and strength.

When the Edible Utensil is bitten, the structure is a crisp yet dense, cookie-like sensation. The basic, unflavored embodiment is slightly sweet. The inside of the Edible Utensil is stacked with layers which form during baking to serve as structural support and insulation. The method used in the raw stages, prior to baking, play a pivotal role in producing the layers. If not done correctly, the interior of the Edible Utensil lacks layers and will most likely jeopardize the intended use.

Taste:

The taste of the Edible Utensil is that of a slightly sweet cookie which will not upstage the food it is meant to compliment as a utensil. Similar to a shortbread cookie, the Edible Utensil is created to withstand elements that an ordinary cookie cannot. Different flavors such as orange, lemon, almond and vanilla may be used.

Shape:

This disclosure references an embodiment of the Edible Utensil relating to a square and/or rectangular stick shape for the purpose of replacing the current wooden ice cream sticks. However, other shape embodiments are suitable for the purpose of offering a variety of fun, interesting shapes as well as for offering unique structural and/or functional properties for the desired utensil's use in a specific food application.

Disc Shape:

The same thickness as sticks. Approximately 2″ diameter disc is baked and slid into a semi-frozen ice cream bar with the manufacturers stick removed and refrozen. The disc has the same permeability, taste, color and consistency, as described above. After the ice cream is eaten, the familiar “cookie” is left to enjoy. One feature of this embodiment is that drips from the ice cream are more easily dealt with (this is due to the length of the stick versus the round disc shape and the gravity factor whereas it is easier to tilt the stick so as not to allow the liquid drips to get on fingers and hands). A disc shape may also be used for an ice cream bar that is more rectangular in shape. This addresses the gravity issue where the cookie handle is more balanced with the ice cream bar.

Pear Shape:

Inspired from a guitar pick, a larger, inverted embodiment may be cut from raw dough and baked in the same manner as other shapes with regard to recipe, thickness, oven temperature and time. The end result is another possible shape which complements the edible utensil. The wider end is suited to hold, while an elongated opposite end is inserted into the confection. Another embodiment includes a hole in the handle portion for aesthetics as well as the functional purpose of providing a better grip.

An embodiment of the Edible Utensil of the present invention is approximately 6 inches long and can vary in length. Its shape may be square, measuring approximately ¼ to ½ inch by ¼ to ½ inch, which can also vary depending on its desired use. Different shapes may also be created with the Edible Utensil recipe. Twisting the dough results in a unique, fun variation which does not jeopardize the structural properties. Sticks can be made into different shapes such as spoons and dull knives for spreading. Sticks can be shaped and used in place of current “wooden spoons” used in the market today.

A selection of exemplary embodiments is presented to illustrate the potential variations in the composition and method of making an edible utensil/support. This list is non-exhaustive.

In Embodiment 1, the invention relates to a method of producing a food product which serves as an Edible Utensil and/or Support where all purpose flour and sugar are combined to form a grain mixture, to which melted butter is added, and the combined grain mixture is mixed to form a slurry. Vanilla extract is optionally added to the slurry. A dough base is formed by adding low-fat milk to the slurry, followed by mixing the dough base for approximately 5 minutes in a standard kitchen mixer to form a wet dough. The wet dough is then kneaded for approximately 10 minutes until an elastic dough ball is obtained. The dough is rested for approximately 1-2 hours, shaped as desired (typically rolled out to a thickness of ⅛ to ¼ of an inch followed by cutting/forming desired shapes), and baked for approximately 45 minutes at approximately 300° F. (Note that bake time may vary depending on oven brand, age and altitude).

| Embodiment 1 | Type | Amount (±20%) |
|---|---|---|
| Powdered Grain (cups) | all purpose flour | 1.5 |
| Fat (cups) | butter | 0.25 |
| Liquid (cups) | low fat milk | 0.5 |
| Sweetener (tsp) | cane sugar | 1.5 |
| Flavoring (tsp) | vanilla extract | 1 |

| | |
|---|---|
| Bake time (min) | 45 |
| Bake temperature (° F.) | 300 |

Embodiment 2 uses whole wheat flour, increased cane sugar and flavoring and an altered bake time and temperature to produce a desirable result.

| Embodiment 2 | Type | Amount (±20%) |
|---|---|---|
| Powdered Grain (cups) | whole wheat flour | 1.5 |
| Fat (cups) | butter | 0.25 |
| Liquid (cups) | low fat milk | 0.75 |
| Sweetener (tsp) | cane sugar | 6 |
| Flavoring (tsp) | vanilla extract | 2 |

| | |
|---|---|
| Bake time (min) | 30 |
| Bake temperature (° F.) | 350 |

Embodiment 3 uses vegetable shortening in place of butter, honey in place of sugar, and skim milk in place of low-fat milk to produce a desirable result.

| Embodiment 3 | Type | Amount (±20%) |
|---|---|---|
| Powdered Grain (cups) | all purpose flour | 1.5 |
| Fat (cups) | veg. shortening | 0.5 |
| Liquid (cups) | skim milk | 0.5 |
| Sweetener (tsp) | honey | 1.5 |
| Flavoring (tsp) | vanilla extract | 1 |

| | |
|---|---|
| Bake time (min) | 30 |
| Bake temperature (° F.) | 350 |

Embodiment 4 uses a non-traditional milk (e.g., soy, rice, buttermilk, lactose-free milk) to produce a desirable result for use with persons with lactose intolerance or dietary restrictions. A food colorant may also be added (in lieu of or in addition to) a flavoring.

| Embodiment 4 | Type | Amount (±20%) |
|---|---|---|
| Powdered Grain (cups) | all purpose flour | 1.5 |
| Fat (cups) | Butter | 0.25 |
| Liquid (cups) | soy or rice milk or | 0.5 |
| | buttermilk or | |
| | lactose free milk | |
| Sweetener (tsp) | Sugar | 1.5 |
| Flavoring (tsp) | food colorant | as needed |

| | |
|---|---|
| Bake time (min) | 30 |
| Bake temperature (° F.) | 350 |

Embodiment 5 uses salt in place of a sweetener to produce a desirable result. Replacing the sugar with salt does not impede anything except for altering the taste. Instead of complimenting confections, such a composition would have more of a biscuit taste which would compliment non-dessert foods or perhaps a frozen vegetable treat.

| Embodiment 5 | Type | Amount (±20%) |
|---|---|---|
| Powdered Grain (cups) | all purpose flour | 1.5 |
| Fat (cups) | butter | 0.25 |
| Liquid (cups) | whole milk | 0.5 |
| Sweetener (tsp) | (salt in lieu of | 1.5 |
| | sweetener) | |
| Flavoring (tsp) | as desired | as needed |

| | |
|---|---|
| Bake time (min) | 60 |
| Bake temperature (° F.) | 275 |

Embodiment 6 uses water (with or without a powdered milk additive as desired) to produce a desirable result. Consistency, structure and texture would not be impeded by substitution of liquid with water.

| Embodiment 6 | Type | Amount (±20%) |
|---|---|---|
| Powdered Grain (cups) | all purpose flour | 1.5 |
| Fat (cups) | butter | 0.25 |
| Liquid (cups) | water (±powdered milk) | 0.5 |
| Sweetener (tsp) | cane sugar | 1.5 |
| Flavoring (tsp) | as desired | as needed |

| | |
|---|---|
| Bake time (min) | 60 |
| Bake temperature (° F.) | 275 |

Embodiment 7 uses no salt and no sweetener; flavoring may instead be used to effect the desired taste to produce a desirable result. Such a composition could be used to effect sugar-free embodiments as desired, or with the addition of artificial and/or natural sweeteners in order to cater to calorie-conscious or dietary-restricted consumers.

| Embodiment 7 | Type | Amount (±20%) |
|---|---|---|
| Powdered Grain (cups) | all purpose flour | 1.5 |
| Fat (cups) | butter | 0.25 |
| Liquid (cups) | milk | 0.5 |
| Sweetener (tsp) | N/A | N/A |
| Flavoring (tsp) | as desired | as needed |

| | |
|---|---|
| Bake time (min) | 45 |
| Bake temperature (° F.) | 300 |

Embodiment 8 uses a non-traditional gluten-free powdered grain (such as, but not limited to, nut flour, brown rice flour, maize flour) and a non-traditional vegan fat (such as, but not limited to, a nut butter) and a non-traditional vegan liquid (such as, but not limited to, soy milk) to produce a desirable result. Such an embodiment would result in a vegan and gluten free composition to cater to a wide variety of dietary restrictions. Sugar could also be omitted (or replaced) as desired.

| Embodiment 8 | Type | Amount (±20%) |
|---|---|---|
| Powdered Grain (cups) | Nut flour or brown rice | 1.5 |
| | flour or maize flour | |
| Fat (cups) | almond (or other nut) | 0.25-0.5 |
| | butter | |
| Liquid (cups) | soy milk | 0.5 |
| Sweetener (tsp) | sugar | 3 |
| Flavoring (tsp) | as desired | as needed |

| | |
|---|---|
| Bake time (min) | 45 |
| Bake temperature (° F.) | 300 |

Cost Effectiveness:

The majority of the wooden sticks currently used are purchased in China, not the United States. Eight billion wooden ice cream sticks are used and tossed in the trash and on streets each year. In addition to contributing to landfill waste, these sticks may splinter and injure the consumer. The majority of these sticks are imported from China due to their large Birch and Poplar tree populations, and low manufacturing costs. It should also be noted that the cost of ingredients is less at wholesale prices and purchased in larger volume. Therefore, the cost of the edible utensil in this application is expected to be lower in a commercial production environment. Lower costs are also expected when manufacturing products such as forks, knives, spoons, scrapers and drink stirrers, using the methods described herein, to replace plastic and wood products of the same variety that are currently in use. The costs detailed below are estimates based on 2012 wholesale prices (and do not include shipping fees, taxes, etc).

| | Price |
|---|---|
| Traditional Wood Stick Cost | |
| 1000 “wooden popsicle sticks- beveled edge” | $26 |
| 1000 “wood ice cream sticks - smooth” | $18 |
| 1000 “wooden ice cream handles” | $15 |
| Avg. cost per stick = 1.966667¢ per stick | 30¢ |
| Edible Utensil/Support Cost | |
| Sugar - 2 lb. (8 cups/48 tsp. per cup) @ 3.29 - | <.1¢ |
| 1.5 tsp | |
| Butter - 1 lb. (4 sticks) @ 2.99 (.75¢ per stick) - | 38¢ |
| ½ stick | |
| Vanilla Extract - 2 oz (12 tsp.) @ 4.99 - 1 tsp | 41¢ |
| Milk (gallon-low fat) @2.99 - 16 cups per gal - | 9¢ |
| ½ cup | |

$1.19 divided by 27 total sticks = 0.04407
<40% for wholesale prices = 2.644¢ per stick

It is noted that the descriptions provided above are based on baking and freezing edible products herein using non-commercial ovens and appliances. Times and temperatures for these processes may vary and can be adjusted for manufacturing in larger scale commercial facilities.

It should be noted that as used herein the terms “first,” “second,” and the like, as well as “primary,” “secondary,” and the like, do not denote any amount, order, or importance, but rather are used to distinguish one element from another, and the terms “a” and “an” do not denote a limitation of quantity, but rather denote the presence of at least one of the referenced item. As used herein the term “about,” when used in conjunction with a number in a numerical range, is defined being as within one standard deviation of the number “about” modifies. Furthermore, the modifier “about” has a meaning dictated by the context. The suffix “(s)” as used herein is intended to include both the singular and the plural of the term that it modifies, thereby including one or more of that term (e.g., the bearings(s) includes one or more bearings). The endpoints of all ranges directed to the same component or property are inclusive and independently combinable (e.g., ranges of “up to about 5°, or, more specifically, about 0.5° to about 3°” is inclusive of the endpoints and all intermediate values of the ranges of “about 0.5° to about 5°,” etc.). “Optional” or “optionally” means that the subsequently described event or circumstances may or may not occur, and that the description includes instances where the event occurs and instances where it does not. The terms “front,” “back,” “bottom,” “top,” “middle” are used herein, unless otherwise noted, merely for convenience of description, and are not limited to any one position or spatial orientation.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 USC §112, sixth paragraph, unless the element is expressly recited using the phrase “means for.”

While the invention has been described with reference to an exemplary or preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims. It is, of course, contemplated that alternative methods, which are well known in the art, may be employed.

Reference throughout the specification to “one embodiment,” another embodiment,” “an embodiment,” and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

The invention claimed is:

1. A food product, comprising:
a frozen treat portion, and
an edible support, wherein the support is substantially embedded in said frozen treat portion.

2. A food product, comprising a cookie, wherein the cookie is substantially impermeable to liquid, substantially durable after freezing, and has a plurality of layers.

3. The food product of claim 2, wherein said layers are each separated by a plurality of air pockets.

4. The food product of claim 1, wherein the edible support comprises:
from 0.75 to 1.25 parts of a fat,
from 2.5 to 3.5 parts of a liquid,
from 5.25 to 6.75 parts of a powdered grain,
a sweetener or a salt, and
optionally, a food-grade flavoring agent.

5. The powdered grain of claim 4, wherein said grain is selected from the group consisting of whole wheat flour, rice flour, and nut flour.

6. A method for producing a food product, the method comprising the steps of:
combining a powdered grain and a sweetener to form a grain mixture,
adding a fat to the grain mixture;
mixing the combined grain mixture and fat to form a slurry;
optionally adding a flavoring to the slurry;
adding milk to the slurry to form a dough base;
mixing the dough base from 2 to 10 minutes to form a wet dough;
kneading the wet dough until an elastic dough ball is obtained;
resting the dough ball for at least 15 minutes to form a dough;
forming the dough into a shape; and
cooking the shape at a temperature of from 275° F. to 375° F. to form a substantially solid food product.
